(19) United States
(12) Patent Application Publication
(10) Pub. No.: US 2015/0379502 A1
(43) Pub. Date: Dec. 31, 2015

(54) IMAGE PROCESSING METHOD OF ENABLING FINANCIAL TRANSACTION AND AN IMAGE PROCESSING SYSTEM THEREOF

(71) Applicant: Wipro Limited, Bangalore (IN)

(72) Inventors: Rakesh Sharma, Hisar (IN); Manoj Madhusudhanan, Bangalore (IN)

(21) Appl. No.: 14/459,428

(22) Filed: Aug. 14, 2014

(30) Foreign Application Priority Data
Jun. 26, 2014 (IN) 3104/CHE/2014

(51) Int. Cl. G06Q 20/32; G06T 7/00; G06T 3/40; G06Q 20/34

(52) U.S. Cl. CPC G06Q 20/3276; G06Q 20/34; G06T 7/0083; G06T 3/40; G06T 7/0042

(57) ABSTRACT

The present subject matter relates to an image processing method and an image processing system for enabling financial transaction. The method comprises capturing an image of a financial instrument using an image capture device. The captured image is then processed to locate image of the financial instrument number and processed to obtain binary images of one or more characters of the financial instrument number. The system further recognizes each character of the financial instrument number from the binary images based on curvature information of each character and accuracy levels. The recognized characters are validated for a possible financial instrument number and then displayed to the user for confirmation. The user may enter at least one input character when the displayed characters is determined to be incorrect and the system updates a character repository with the correct financial instrument number and corresponding accuracy level.

This application claims the benefit of Indian Patent Application Serial No. 3104/CHE/2014 filed Jun. 26, 2014, which is hereby incorporated by reference in its entirety.

### FIELD

The present subject matter is related, in general to an image processing technique, and more particularly, but not exclusively to an image processing method and system for enabling financial transactions.

### BACKGROUND

Physical financial information such as found in financial instruments, include, but are not limited to credit cards, debit cards, gift cards, loyalty memberships cards are commonly used in financial transactions. The financial instruments may be used in financial transactions between a variety of individuals, businesses, and organizations. For example, credit cards may be used to purchase goods or services, pay for business expenses, borrow money and/or donate money. Sale points, for example Point of Sale terminals allow customers to purchase products and services using the customer's credit and debit cards. Card based monetary transactions are usually carried out by the systems that can either read data from a magnetic strip attached to the card enabling the system to read details of the card for identification or by manually entering the card number and other card details such as the name of the card owner and the expiry date of the card.

Businesses and merchants may encounter various difficulties and costs in processing card based transactions. For example, merchant service providers and payment processors often charge service charges for processing credit card payments on merchant's behalf. These service charges are applicable for all transactions including failed transactions in which the card details were incorrectly entered by the merchant or card holder. Further, the charges may also vary based on the nature of the transaction. Hence there exists a need to provide a solution which accurately acquires the card details from the card and avoid failing of transactions.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to an image processing method of enabling a financial transaction by a processor configured in an image processing system. The method comprises receiving at least one image of a financial instrument from a sensor and detecting the presence of the financial instrument in the at least one image. Upon detecting, identifying the location of the at least one financial instrument number in the at least one image and obtaining a binary image of each character of the at least one financial instrument number from the identified location. The binary image of each character thus obtained is then segmented into one or more segments. The method further comprising recognizing each character of the at least one financial instrument number by determining curvature information of all the segments for each character based on one or more attributes including a first accuracy level of the character of the at least one financial instrument number.

Further, the present disclosure relates to an image processing system for enabling a financial transaction. The system comprises a sensor configured to capture at least one image of a financial instrument and a processor communicatively coupled to the sensor. The system further comprises a memory communicatively coupled to the processor, wherein the memory stores processor-executable instructions, which, on execution, causes the processor to receive at least one input image of a financial instrument from the sensor. The processor is further configured to detect the presence of the financial instrument in the at least one image and identify location of the at least one financial instrument number in the at least one image upon detecting the presence of the financial instrument. Based on the identified location, the processor obtains a binary image of each character of the at least one financial instrument number. The processor is further configured to segment the binary image of each character into one or more segments and recognize each character of the at least one financial instrument number by determining curvature information of all the segments for each character. The curvature information is determined based on one or more attributes including a first accuracy level of the character of the at least one financial instrument number.

Furthermore, the present disclosure relates to a non-transitory computer readable medium including instructions stored thereon that when processed by at least one processor cause a system to receive at least one input image of a financial instrument from the sensor. The processor detects the presence of the financial instrument in the at least one image and identifies location of the at least one financial instrument number in the at least one image upon detecting the presence of the financial instrument. Based on the identified location, the processor obtains a binary image of each character of the at least one financial instrument number from the identified location and segments the binary image of each character into one or more segments. The processor further performs recognizing each character of the at least one financial instrument number by determining curvature information of all the segments for each character based on one or more attributes including a first accuracy level of the character of the at least one financial instrument number.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates architecture of system for enabling image based financial transactions in accordance with some embodiments of the present disclosure;

FIG. 2 illustrates a block diagram of an image processing system for enabling financial transactions in accordance with some embodiments of the present disclosure;

FIG. 3A illustrates a view of one or more segments of binary image of character in accordance with some embodiments of the present disclosure;

FIG. 3B illustrates an exemplary view of segmented binary image of character in accordance with some embodiments of the present disclosure;

FIG. 4 illustrates a flowchart of an image processing method of enabling financial transactions in accordance with some embodiments of the present disclosure;

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Accordingly, the present disclosure provides a process for extracting physical financial information from a financial instrument. The physical financial information includes, but not limited to, financial instrument holders Name, expiry date, financial instrument number, for example credit card number, and Card Verification Value (CVV) number. The process which is developed as application may be deployed with any of the computing devices having and/or associated with image sensor, for example camera. This application captures the image of the financial instrument and may detect physical financial information location from the image. Further, the application extracts and recognizes the financial instrument number. In one embodiment, the application provides an opportunity to edit the detected financial instrument number in case there is any error in the detected financial instrument number. If the user modifies the detected financial instrument number, the application learns and adapts itself for the next usage.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

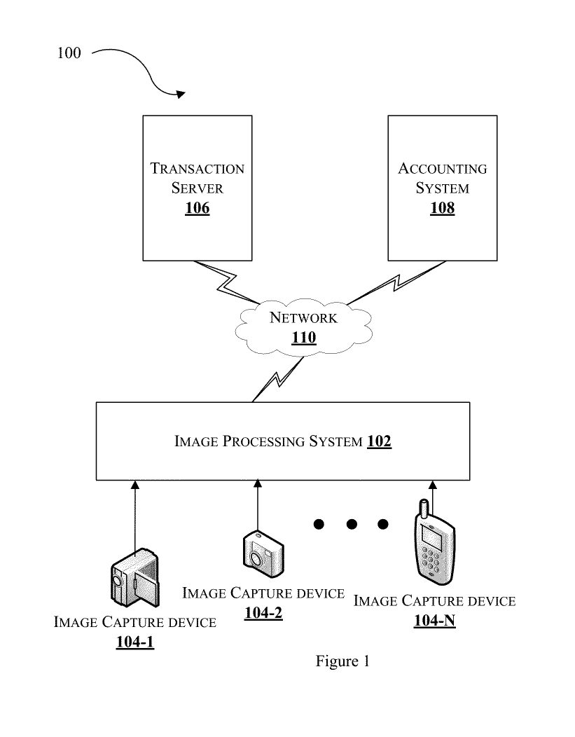

FIG. 1 illustrates architecture of system for enabling image based financial transactions in accordance with some embodiments of the present disclosure.

As shown in FIG. 1, a system 100 for enabling image based financial transactions comprises one or more components coupled with each other. In one implementation, the system 100 comprises an image processing system 102 communicatively coupled with one or more image capture devices 104-1, 104-2, . . . , 104-N (hereinafter, collectively referred to as image capture device 104). Examples of the image processing system 102 includes, but is not limited to, a desktop computer, a portable computer, a mobile phone, a handheld device, and Point of Sale (POS) terminal. The image capture device or image sensor (alternately referred to as sensor) 104 is configured to capture image of at least one financial instrument (alternatively referred as a transaction card) to enable processing of a financial transaction using the at least one financial instrument. In one example, the at least one financial instrument is placed in front of the image capture device 104 or within the field of view of the image capture device 104. Examples of the image capture device 104 include, but not limited to, an image sensor or a camera corresponding to a mobile/smart phone, a still camera, a video camera, or a webcam on a laptop computer.

The image capture device 104 may record still and/or video image using a lens and a digital image sensor. In another implementation, any other hardware or software that captures the image of the at least one financial instrument. The image recorded by the image capture device 104 may additionally be stored in a storage medium of the image capture device 104. The image captured by the image capture device 104 is then transmitted to the image processing system 102.

The image processing system 102 is communicatively coupled to a transaction server 106 and an accounting system 108 through a network 110 for facilitating the financial transactions. The network 110 may be a wireless network, wired network or a combination thereof. The network 110 can be implemented as one of the different types of networks, such as intranet, local area network (LAN), wide area network (WAN), the internet, and such. The network 110 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 110 may include a variety of network devices, including routers, bridges, servers, computing devices, storage devices, etc.

The transaction server 106 includes a desktop personal computer, workstation, laptop, PDA, cell phone, or any WAP-enabled device or any other computing device capable of interfacing directly or indirectly to the Internet or other network connection. The transaction server 106 may include at least one processor with associated system memory, which may enable processing of financial transactions. The transaction server 106 may further include additional memory, which may, for example, include instructions to perform various processes of financial transactions. The memory and other memory may comprise separate memory devices, a single shared memory device or a combination of separate and shared memory devices. The transaction server 106 typically includes one or more user interface devices, such as a keyboard, a mouse, touch screen, pen or the like, for interacting with the GUI provided on a display.

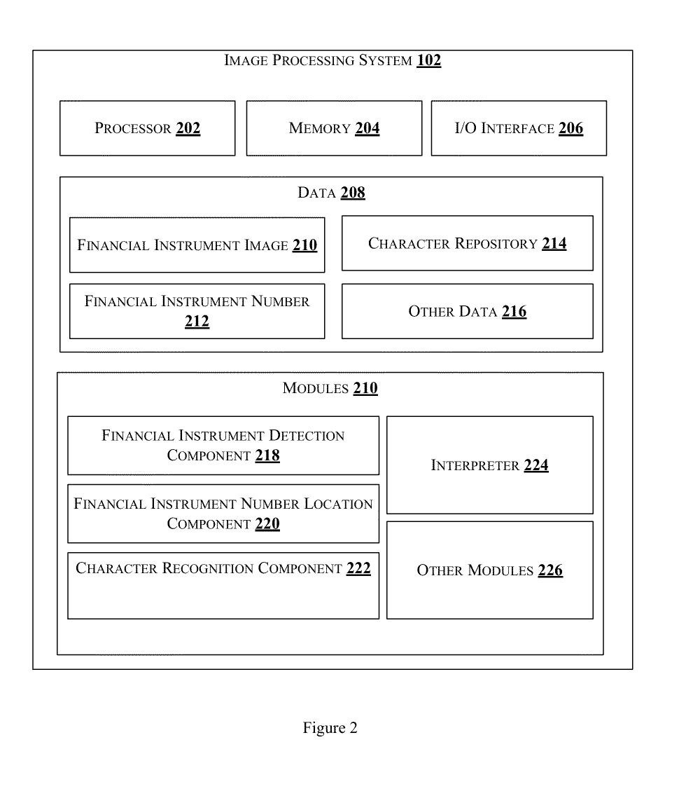

The image processing system 102 is configured to receive the captured images of the at least one financial instrument and recognize a financial instrument data from the received financial instrument image. The financial instrument data may be, for example, a financial instrument number, name of the financial instrument holder, or expiry date associated with the at least one financial instrument. In one implementation, the image processing system 102, as shown in FIG. 2, includes a central processing unit (“CPU” or “processor”) 202, a memory 204 and an Interface 206. Processor 202 may comprise at least one data processor for executing program components and for executing user- or system-generated requests. A user may include a person, a person using a device such as those included in this disclosure, or such a device itself. The processor 202 may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 202 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc. Among other capabilities, the processor 202 is configured to fetch and execute computer-readable instructions stored in the memory 204. The memory 204 can include any non-transitory computer-readable medium known in the art including, for example, volatile memory (e.g., RAM), and/or non-volatile memory (e.g., EPROM, flash memory, etc.).

The interface(s) 206 may include a variety of software and hardware interfaces, for example, a web interface, a graphical user interface, etc. The interface 206 is coupled with the processor 202 and an I/O device. The I/O device is configured to receive inputs from the image capture device 102 via the interface 206 and transmit outputs for displaying in the I/O device via the interface 206.

The image processing system 102 further comprises data 208 and modules 210. In one implementation, the data 208 and the modules 210 may be stored within the memory 204. In one example, the modules 210, amongst other things, include routines, programs, objects, components, and data structures, which perform particular tasks or implement particular abstract data types. The modules 210 may also be implemented as, signal processor(s), state machine(s), logic circuitries, and/or any other device or component that manipulate signals based on operational instructions. Further, the modules 210 can be implemented by one or more hardware components, by computer-readable instructions executed by a processing unit, or by a combination thereof.

In one implementation, the data 208 may include, for example, image of at least one financial instrument 210, financial instrument data 212, character repository 214 and other data 216. In one embodiment, the data 208 may be stored in the memory 204 in the form of various data structures. Additionally, the aforementioned data can be organized using data models, such as relational or hierarchical data models. The other data 216 may be used to store data, including temporary data and temporary files, generated by the modules 210 for performing the various functions of the image processing system 102.

The modules 210 may include, for example, a financial instrument detection component 218, a financial instrument number location engine 220, a character recognition engine 222, and interpreter 224 coupled with the processor 202. The modules 210 may also comprise other modules 226 to perform various miscellaneous functionalities of the image processing system 102. It will be appreciated that such aforementioned modules may be represented as a single module or a combination of different modules.

In operation, the financial instrument detection component 218 receives the captured image from the image capture device 102 and detects the presence of the at least one financial instrument within the captured image. In one example, the captured image represents images of one or more financial instruments 210 such as credit card, debit card, and gift card etc., based on which a financial transaction is implemented. The financial instrument detection component 218 determines as to whether the one or more financial instrument images 210 represents a valid financial instrument based on physical characteristics of the at least one financial instrument such as size and appearance, including known standards such as aspect ratios and the like relating to various types of financial instruments.

If the at least one financial instrument is partially detected or not detected by the financial instrument detection component 218, the user is then guided to locate the financial instrument within the field of view of the image capture device or the image sensor 102. The user may be, for example a card holder, salesman, trader, retailer or any other person involved in conducting transaction card based monetary transactions by extracting the details of the financial instrument. The user is guided by the image processing system 102 in locating the at least one financial instrument within the field of view of the image capture device or the image sensor 104 such that the image of the at least one financial instrument is captured within a frame so as to obtain an optimal image of the at least one financial instrument. The frame includes dimensions corresponding to the aspect ratio of the financial instrument and the user may position the financial instrument within the view of the image capture device 104 and use the frame to properly position the financial instrument. In one example, the frame provides a color coded feedback indicating alignment of the financial instrument within the view of the image capture device 104. If the financial instrument detection component 218 determines that the one or more financial instrument images 210 represents a valid financial instrument, then the location of the financial instrument number 212 is identified by the financial instrument number location component 220.

The financial instrument number location component 220 identifies the location of the at least one financial instrument number 212 in the one or more financial instrument images 210. The financial instrument number location component 220 converts the one or more financial instrument images 210 into one or more corresponding binary images and identify one or more group of characters from the binary images. In one implementation, the financial instrument number location component 220 identifies one or more group of characters associated with the financial instrument number 212. One or more group of characters may be at least four groups of characters, each group containing 4 numbers of characters. Upon identifying the one or more group of characters, the location of each group is then determined by the financial instrument number location component 220, which represent the location of the financial instrument number 212. Once the location of the financial instrument number 212 is identified, image of the financial instrument number 212 is cropped and further processed by the character recognition component 222 to obtain binary image of each character of the one or more group of characters and recognize each character of the financial instrument number 212.

The character recognition component 222 receives the image of the financial instrument 210 from the financial instrument number location component 220 and obtains binary image of each character of the financial instrument number 212. In one implementation, the character recognition component 222 obtains an image of the financial instrument number 212 cropped from the image of the financial instrument 210 in the identified location and converts the cropped image into a corresponding binary image. The binary image is further processed to obtain the binary image of each character of the financial instrument number 212. The character recognition component 222 detects a sequential increase and a decrease in the count of white pixels in the binary image indicating presence of a character of predetermined size.

In one implementation, the character recognition component 222 detects a sharp increase in the count of white pixels in the X direction i.e., in horizontal direction indicative of beginning of a character and continuously searches for pixels until a sudden decrease in the count of white color pixels is determined. Once the immediate decrease in the count of white pixels is determined, then the search has reached to the end of the character. The character recognition component 222 is configured to search for white pixels and determine a sudden increase and sequential decrease in the count of white pixels during the search thus detecting each character of the financial instrument number 212. Upon detecting each character of the financial instrument number 212, the character recognition component 222 obtains the binary image of each such character by cropping the binary image of each character based on the count of white pixels in ‘Y’ direction. In one implementation, the character recognition component 222 determines a sudden increase in the count of white color pixels in the ‘Y’ direction from above the character and crops the extra image present above the character. Further, the character recognition component 222 determines a sudden increase in the count of white color pixels in the ‘Y’ direction from below the character and crops the extra image present below the character.

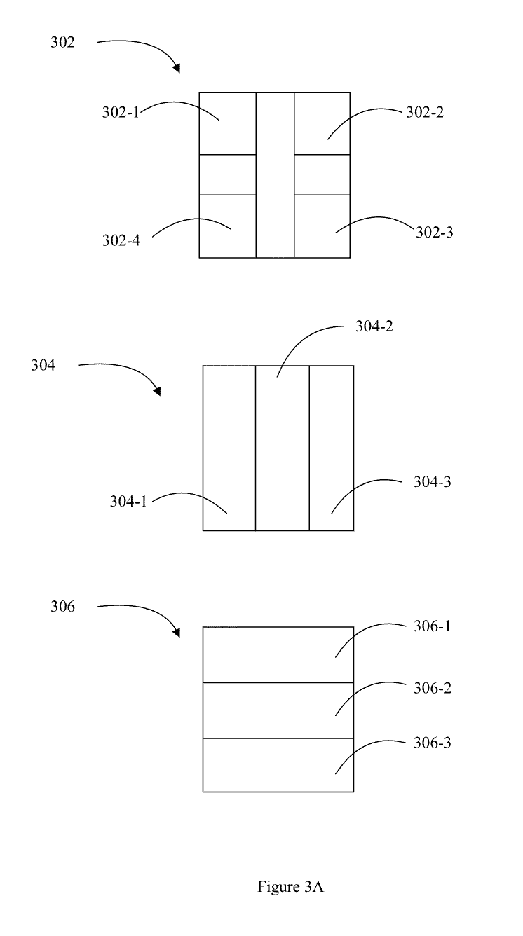

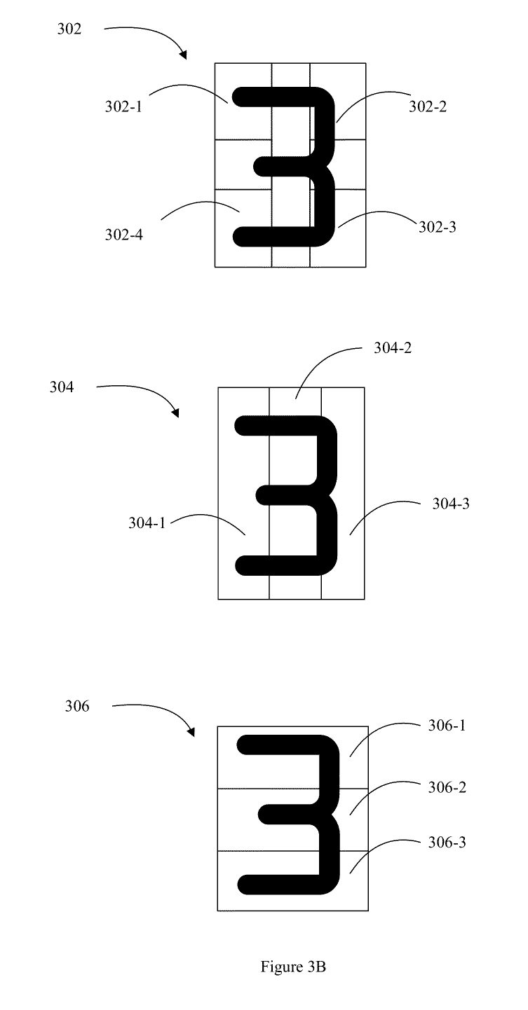

The character recognition component 222 is further configured to recognize each character of the financial instrument number 212 from the cropped binary image of each character. In a first implementation, the character recognition component 222 recognizes the character of the financial instrument number 212 based on curvature information of the image. The character recognition component 222 segments the binary image of each character into one or more segments and identifies a character by determining curvature information of all the segments based on one or more attributes. The character recognition component 222 segments the binary image of each character into the one or more segments in one or more different implementations as depicted by 302, 304 and 306 of FIG. 3A. In one implementation, the binary image of each character is divided into segments or alternatively referred as blocks including top-left block 302-1, top-right block 302-2, bottom-right block 302-3 and bottom-left block 302-4. In second implementation, the binary image of each character is divided into segments such as mid-left block 304-1, mid-center block 304-2 and mid-right block 304-3. In third implementation, the binary image of each character is divided into segments such as top block 306-1, mid block 306-2 and bottom block 306-3. An exemplary diagram showing the segmentation of binary image of character for example, ‘3’ into blocks 302, 304 and 306 are illustrated in FIG. 3B.

Upon segmenting the binary image of each character into the one or more blocks/segments using one or more of the implementation methods 302, 304 and 306 as described above, the character recognition component 222 determines the curvature information of each block. In one implementation, the character recognition component 222 curves/lines expands the curves/lines in each segment in order to join the breaks present in the curves/lines and determines as to whether the length of each expanded curve/line in that segment exceeds a predetermined threshold value. In one example, the character recognition component 222 expands the curves/lines by expanding or inflating white color pixels in each segment and joins the gap present in curve/line and detects the presence of curves/lines based on the length of the expanded curves/lines.

If it is determined that the length of each expanded curve/line exceeds the predetermined threshold, then the expanded curve/line is assumed to be present in that segment. Detection of presence of curves/lines in each segment is indicative of the curvature information for the segment. Once the curvature information for each segment is determined, then a first probable character present in the binary image of that character is recognized with a certain accuracy level or confidence level based on the curvature information and one or more attributes. The one or more attributes define the quality of the character's image and a first accuracy level indicating the probability that the character identification is accurate. The first accuracy level (alternately referred to as first confidence level) may be predetermined probability value indicating the accuracy of the character present in the binary image.

The character recognition component 222 also determines a second probable character present in each binary image based on the curvature information and a second accuracy level, wherein the second accuracy level is lesser than the first accuracy level.

In second implementation, the characters of the financial instrument number 212 may be recognized from the cropped binary image of each character based on one or more predefined images stored in the memory 204. The character recognition component 222 compares the cropped binary image of each character with the one or more predefined images and determines a match between the images. If a match is determined between the binary image of each character and the one or more predefined images, then a third probable character of the matched image is determined, which is having a first accuracy level of the matched predefined image. Further, if the binary image of each character matches entirely or in part with another predefined image, then a fourth probable character of the matching image with a second accuracy level is determined. The character recognition component 222 stores the first, the second, the third and the fourth probable characters recognized from each binary image of character in an order of first and second accuracy levels in the character repository 214.

Further, the character recognition component 222 determines the validity of the financial instrument number 212 represented by the recognized characters. In one implementation, the character recognition component 222 determines the validity of the financial instrument number 212 represented by the first probable characters having first accuracy level. In this context, validating the characters of the financial instrument number 212 does not refer to authenticating the financial instrument number 212 or authorizing a transaction using the financial instrument number 212. Instead, validation refers to an initial determination of whether the financial instrument number 212 can be subjected to authentication or authorization. Validation, for example, includes determining whether the characters of the financial instrument number 212 correspond to a possible financial instrument number. In one implementation, the character recognition component 222 determines whether the recognized characters of the financial instrument number 212 is a valid financial instrument number 212. In one example, Luhn's algorithm/technique is employed to check for valid financial instrument number. In another example, any other checksum functions or techniques may be employed.

If it is determined that the recognized first probable characters indicate an invalid financial instrument number 212, then the character recognition component 222 determines the validity of the second probable characters having the second accuracy level. If the validity of the financial instrument number is still found to be invalid, then the validity of the financial instrument number 212 represented by the third or the fourth probable characters is determined. If it is determined that any of the first, second, third, fourth probable characters indicate a valid financial instrument number 212, and then the validated financial instrument number 212 is displayed via the output device to the user or the card holder for confirmation.

The character recognition component 222 checks whether the financial instrument number 212 thus determined has sufficient accuracy level before displaying the financial instrument number 212 to the user. In one implementation, the character recognition component 222 determines whether a predetermined number of characters ‘x’ of the total characters ‘n’ of the financial instrument number 212 have sufficient accuracy level i.e., accuracy level above a predetermined threshold value. If the determination is TRUE, then the financial instrument number 212 is displayed to the user with the ‘n-x’ characters displayed in a different color. For example, if x is 11, then it is determined whether 11 characters out of total 16 characters have accuracy level above the predetermined threshold value and if the determination is TRUE, then the remaining 5 characters are displayed in a different color to the user. If the determination is FALSE, then the entire image processing method begins again with capturing the image of the financial instrument by the image capture device 102 and processing of the captured image by the financial instrument detection component 218, financial instrument number location component 220 and character recognition component 222 to obtain the financial instrument number 212.

The output device displays the valid financial instrument number 212 to the user or the card holder. The user may input at least one character as input via the I/O interface 206 if the user determines an incorrect character in the financial instrument number 212 thus displayed. The input device receives the at least one input character from the user and stores in the memory 204. The interpreter 224 retrieves the at least one input character from the memory 204 and updates the character repository 214 with a corresponding accuracy level. The interpreter 224 updates the character repository with the correct financial instrument number 212 and corresponding accuracy levels.

On determining the valid financial instrument number 212, the image processing system 102 transmits a request to the transaction server 106 for processing the financial transaction using the financial instrument number 212. The request may be to authorize the requested transaction or a request to both authorize and process the transaction. Upon processing the transaction, the user is provided with an indication indicating that the transaction is processed. The information and details related to the transaction and financial instrument number 212 is then recorded in the accounting system 108 for future purposes.

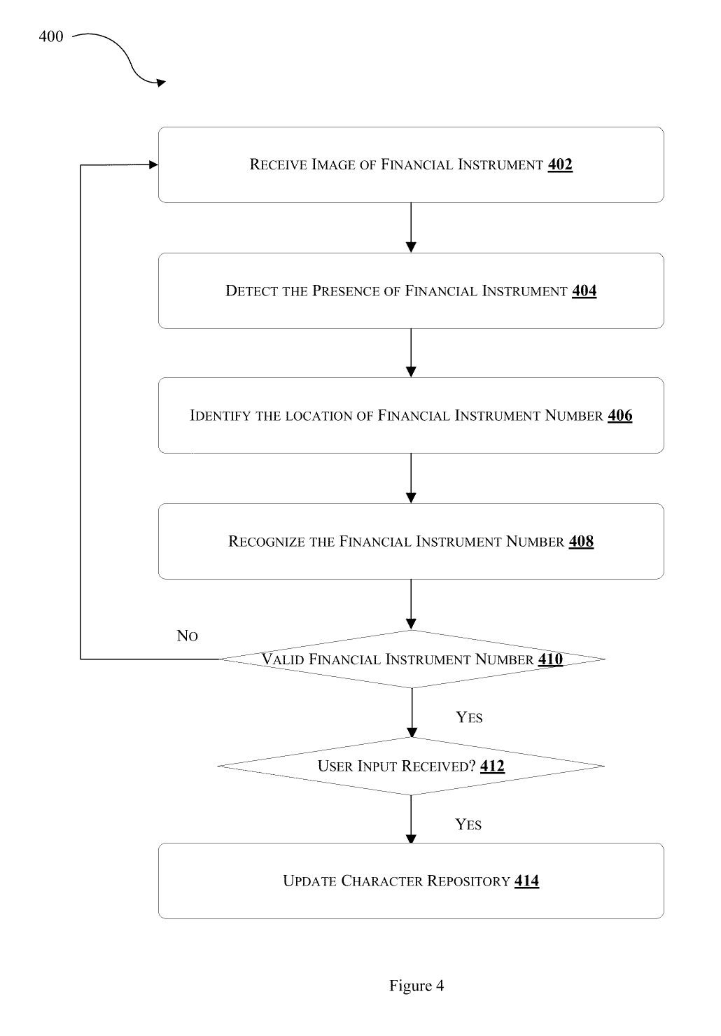

FIG. 4 illustrates a flowchart of an image processing method of enabling financial transactions in accordance with an embodiment of the present disclosure.

As illustrated in FIG. 4, the method 400 comprises one or more blocks implemented by the image processing system 102 for enabling financial transactions. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method 400. Additionally, individual blocks may be deleted from the method 400 without departing from the spirit and scope of the subject matter described herein. Furthermore, the method 400 can be implemented in any suitable hardware, software, firmware, or combination thereof.

At block 402, receive image of the financial instrument. In one embodiment, the financial instrument detection component 218 receives the captured image from the image capture device 102. In one example, the captured image represents images of one or more financial instruments 210 such as credit card, debit card, and gift card etc., based on which a financial transaction is implemented.

At block 404, detect the presence of financial instrument. In one embodiment, the financial instrument detection component 218 detects the presence of the at least one financial instrument within the captured image. The financial instrument detection component 218 determines as to whether the one or more financial instrument images 210 represents a valid financial instrument based on physical characteristics of the at least one financial instrument such as size and appearance, including known standards such as aspect ratios and the like relating to various types of financial instruments.

In one implementation, if the at least one financial instrument is partially detected by the financial instrument detection component 218, the user is then guided to locate the financial instrument within the field of view of the image capture device or the image sensor 102. In another implementation, the user is guided to locate the financial instrument within the field of view of the image capture device 102 when the presence of the financial instrument is not detected by the financial instrument detection component 218. The user is guided by the image processing system 102 in locating the at least one financial instrument within the field of view of the image capture device or the image sensor 104 such that the image of the at least one financial instrument is captured within a frame so as to obtain an optimal image of the at least one financial instrument. The frame includes dimensions corresponding to the aspect ratio of a financial instrument and the user may position the financial instrument within the view of the image capture device 104 and use the frame to properly position the financial instrument. If the financial instrument detection component 218 determines that the one or more financial instrument images 210 represents a valid financial instrument, then the location of the financial instrument number 212 is identified by the financial instrument number location component 220.

At block 406, identify the location of financial instrument number. In one embodiment, the financial instrument number location component 220 identifies the location of the at least one financial instrument number 212 in the one or more financial instrument images 210. The financial instrument number location component 220 converts the one or more financial instrument images 210 into one or more corresponding binary images and identify one or more group of characters from the binary images. In one implementation, the financial instrument number location component 220 identifies one or more group of characters associated with the financial instrument number 212. One or more group of characters may be at least four groups of characters, each group containing 4 numbers of characters. Upon identifying the one or more group of characters, the location of each group is then determined by the financial instrument number location component 220, which represent the location of the financial instrument number 212. Once the location of the financial instrument number 212 is identified, image of the financial instrument number 212 is cropped and further processed by the character recognition component 222 to obtain binary image of each character of the one or more group of characters and recognize each character of the financial instrument number 212.

The character recognition component 222 receives the image of the financial instrument 210 from the financial instrument number location component 220 and obtains binary image of each character of the financial instrument number 212. In one implementation, the character recognition component 222 obtains an image of the financial instrument number 212 cropped from the image of the financial instrument 210 in the identified location and converts the cropped image into a corresponding binary image. The binary image is then processed to obtain the binary image of each character of the financial instrument number 212. The character recognition component 222 detects a sequential increase and a decrease in the count of white pixels in the binary image indicating presence of a character of predetermined size.

In one implementation, the character recognition component 222 detects a sharp increase in the count of white pixels in the X direction i.e., in horizontal direction indicative of beginning of a character and continuously searches for pixels until a sudden decrease in the count of white color pixels is determined. Once the immediate decrease in the count of white pixels is determined, then the search has reached to the end of the character. The character recognition component 222 is configured to search for white pixels and determine a sudden increase and sequential decrease in the count of white pixels during the search thus detecting each character of the financial instrument number 212. Upon detecting each character of the financial instrument number 212, the character recognition component 222 obtains the binary image of each such character by cropping the binary image of each character based on the count of white pixels in ‘Y’ direction. In one implementation, the character recognition component 222 determines a sudden increase in the count of white color pixels in the ‘Y’ direction from above the character and crops the extra image present above the character. Further, the character recognition component 222 determines a sudden increase in the count of white color pixels in the ‘Y’ direction from below the character and crops the extra image present below the character.

At block 408, recognize the financial instrument number. In one implementation, the character recognition component 222 is configured to recognize each character of the financial instrument number 212. In a first implementation, the character recognition component 222 recognizes the character of the financial instrument number 212 based on curvature information of the image. The character recognition component 222 segments the binary image of each character into one or more segments and identifies a character by determining curvature information of all the segments based on one or more attributes. The character recognition component 222 segments the binary image of each character into the one or more segments in one or more different implementations as depicted by 302, 304 and 306 of FIG. 3A. In one implementation, the binary image of each character is divided into segments/blocks including top-left block 302-1, top-right block 302-2, bottom-right block 302-3 and bottom-left block 302-4. In second implementation, the binary image of each character is divided into segments such as mid-left block 304-1, mid-center block 304-2 and mid-right block 304-3. In third implementation, the binary image of each character is divided into segments such as top block 306-1, mid block 306-2 and bottom block 306-3.

Upon segmenting the binary image of each character into the one or more segments using one or more of the implementation methods 302, 304 and 306 as described above, the character recognition component 222 determines the curvature information of each segment. In one implementation, the character recognition component 222 expands the curves/lines in each segment in order to join the breaks present in the curves/lines and determines as to whether the length of each expanded curve/line in that segment exceeds a predetermined threshold value. In one example, the character recognition component 222 expands the curves/lines by expanding or inflating white color pixels in each segment and joins the gap present in curve/line and detects the presence of curve/line based on the length of the expanded curve/line.

If it is determined that the length of each expanded curve/line exceeds the predetermined threshold, then the expanded curve/line is assumed to be present in that segment. Detection of presence of curves/lines in each segment is indicative of the curvature information for the segment. Once the curvature information for each segment is determined, then a first probable character present in the binary image of that character is recognized with a certain accuracy level or confidence level based on the curvature information and one or more attributes. The one or more attributes define the quality of the character's image and a first accuracy level indicating the probability that the character identification is accurate. The first accuracy level (alternately referred to as first confidence level) may be predetermined probability value indicating the accuracy of the character present in the binary image. The character recognition component 222 also determines a second probable character present in each binary image based on the curvature information and a second accuracy level, wherein the second accuracy level is lesser than the first accuracy level.

In second implementation, the characters of the financial instrument number 212 may be recognized from the cropped binary image of each character based on one or more predefined images stored in the memory 204. The character recognition component 222 compares the cropped binary image of each character with the one or more predefined images and determines a match between the images. If a match is determined between the binary image of each character and at least one predefined image, a third probable character of the matching image having a first accuracy level of the matching predefined image is determined. Further, if the binary image of each character matches entirely or in part with another predefined image, then a fourth probable character of the matching image with a second accuracy level is determined. The character recognition component 222 stores the first, the second, the third and the fourth probable characters recognized from each binary image of character in order of first and second accuracy levels in the character repository 214.

At block 410, financial instrument number is validated. In one implementation, the character recognition component 222 determines the validity of the financial instrument number 212 represented by the first probable characters having first accuracy level. If it is determined that the financial instrument number is valid, then the method proceeds to block 412 via “YES” path, otherwise proceeds to block 402 via “NO” path to restart the image processing method 400. In another implementation, if it is determined that the recognized first probable characters indicate an invalid financial instrument number 212, then the character recognition component 222 determines the validity of the second probable characters having the second accuracy level. If the validity of the financial instrument number is still found to be invalid, then the validity of the financial instrument number 212 represented by the third or the fourth probable characters is determined. If it is determined that any of the first, second, third, fourth probable characters indicate a valid financial instrument number 212, and then the validated financial instrument number 212 is then displayed via the output device to the user or the card holder for confirmation.

At block 412, user input received. In one implementation, if the financial instrument number is determined as valid, then the method proceeds to check whether the financial instrument number 212 thus determined has sufficient accuracy level before displaying the financial instrument number 212 to the user. In one implementation, the character recognition component 222 determines whether a predetermined number of characters ‘x’ of the total characters ‘n’ of the financial instrument number 212 have accuracy level above a predetermined threshold value. If the determination is TRUE, then the financial instrument number 212 is displayed to the user with the ‘n-x’ characters displayed in a different color. If the determination is FALSE, then the entire image processing method begins again with capturing the image of the financial instrument by the image capture device 102 and processing of the captured image by the financial instrument detection component 218, financial instrument number location component 220 and character recognition component 222 to obtain the financial instrument number 212.

The output device displays the valid financial instrument number 212 to the user or the card holder. The user may input at least one character as input via the I/O interface 206 if the user determines an incorrect character in the financial instrument number 212 thus displayed. The input device receives the at least one input character from the user and stores in the memory 204.

At block 414, update character repository. In one implementation, the interpreter 224 retrieves the at least one input character from the memory 204 and updates the character repository 214 with a corresponding accuracy level. The interpreter 224 updates the character repository with the correct financial instrument number 212 and corresponding accuracy levels.

On determining the valid financial instrument number 212, the image processing system 102 transmits a request to the transaction server 106 for processing the financial transaction using the financial instrument number 212. The request may be to authorize the requested transaction or a request to both authorize and process the transaction. Upon processing the transaction, the user is provided with an indication indicating that the transaction is processed. The information and details related to the transaction and financial instrument number 212 is then recorded in the accounting system 108 for future purposes.

The specification has described a method and a system for providing real time remote expert guidance to a novice user to accomplish a task. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. An method for enabling a financial transaction comprising:
receiving, by a processor of an image processing device, at least one image of a financial instrument from a sensor;
detecting, by the image processing device, the presence of the financial instrument in the at least one image;
identifying, by the image processing device, a location of at least one financial instrument number in the financial instrument;
obtaining, by the image processing device, a binary image of each character of the at least one financial instrument number from the identified location;
segmenting, by the image processing device, the binary image of each character into one or more segments; and
recognizing, by the image processing device, each character of the at least one financial instrument number by determining curvature information of the one or more segments for each character based on one or more attributes.

2. The method as set forth in claim 1, further comprising:
guiding, by the image processing device, a user, associated with the financial instrument, to locate the financial instrument within a field of view of the sensor when the presence of the financial instrument in the field of view of the sensor is partially detected by the image processing device.

3. The method as set forth in claim 1, wherein identifying the location of the at least one financial instrument number comprises:
converting, by the image processing device, the at least one image into a corresponding binary image;
identifying, by the image processing device, at least one group of characters associated with the at least one financial instrument number from the binary image;
determining, by the image processing device, the location of the at least one group of characters; and
identifying, by the image processing device, the location of the at least one financial instrument number based the location of the at least one group of characters.

4. The method as set forth in claim 1, wherein obtaining the binary image of each character in the at least one financial instrument number comprises:
cropping, by the image processing device, the at least one image of the at least one financial instrument number from the identified location for each of the at least one images;
converting, by the image processing device, the cropped image into a corresponding binary image; and
detecting, by the image processing device, an increase in a count of white color pixels in a first location in the binary image;
detecting, by the image processing device, a corresponding decrease in a count of white color pixels in a second location in the binary image; and
obtaining, by the image processing device, the binary image of each character of the at least one financial instrument number based on the detected increase in the count of white color pixels in a first location in the binary image and the corresponding decrease in the count of white color pixels in a second location of the binary image.

5. The method as set forth in claim 1, wherein determining the curvature information of each segment comprises:
expanding, by the image processing device, at least one of curves or lines and nullifying a gap in the one or more segments, wherein the curvature information is indicative of a presence of the at least one of the curves and lines in each segment;
determining, by the image processing device, the length of one of the expanded curves or lines;
determining, by the image processing device, whether the length of the one of the expanded curves or lines exceeds a predetermined threshold; and
detecting, by the image processing device, the presence of the one of the expanded curves or lines based on the determination.

6. The method as set forth in claim 1, wherein the one or more attributes define a quality of the image of each character and a first accuracy level indicating a probability that the character identification is accurate.

7. The method as set forth in claim 6, wherein recognizing each character of the at least one financial instrument number comprises:
comparing, by the image processing device, the binary image of each character in the at least one financial instrument number with one or more predefined images; and
determining, by the image processing device, a matching predefined image of each character having a second accuracy level;
selecting, by the image processing device, each character having a maximum of the first and the second accuracy levels;
determining, by the image processing device, whether the first and second accuracy levels of each selected character exceed a predetermined threshold; and
displaying, by the image processing device, the characters of the at least one financial instrument number to a user for confirmation.

8. The method as set forth in claim 7, further comprising:
validating, by the image processing device, the at least one financial instrument number prior to displaying the at least one financial instrument number to the user.

9. The method as set forth in claim 7, further comprising:
receiving, by the image processing device, at least one character associated with the at least one financial instrument number as an input from the user when at least one character is determined to be incorrect in the at least one financial instrument number being displayed; and
updating, by the image processing device, the input character along with the corresponding accuracy level into a character repository.

10. An image processing device comprising:
a processor coupled to a memory and configured to execute programmed instructions stored in the memory, comprising:
receiving at least one image of a financial instrument from a sensor communicatively coupled to the image processing device;
detecting the presence of the financial instrument in the at least one image;
identifying a location of at least one financial instrument number in the financial instrument;
obtaining a binary image of each character of the at least one financial instrument number from the identified location;
segmenting the binary image of each character into one or more segments; and
recognizing each character of the at least one financial instrument number by determining curvature information of the one or more segments for each character based on one or more attributes.

11. The device as set forth in claim 10, wherein the processor is further configured to execute programmed instructions stored in the memory further comprising:
guiding a user, associated with the financial instrument, to locate the financial instrument within a field of view of the sensor when the presence of the financial instrument in the field of view of the sensor is partially detected by the image processing device, wherein the one or more attributes define a quality of the image of each character and a first accuracy level indicating a probability that the character identification is accurate.

12. The device as set forth in claim 10, wherein identifying the location of the at least one financial instrument number further comprises:
converting the at least one image into a corresponding binary image;
identifying at least one group of characters associated with the at least one financial instrument number from the binary image;
determining the location of the at least one group of characters; and
identifying the location of the at least one financial instrument number based the location of the at least one group of characters.

13. The device as set forth in claim 10, obtaining the binary image of each character in the at least one financial instrument number further comprises:
cropping the at least one image of the at least one financial instrument number from the identified location for each of the at least one images;
converting the cropped image into a corresponding binary image; and
detecting an increase in a count of white color pixels in a first location in the binary image;
detecting a corresponding decrease in a count of white color pixels in a second location in the binary image; and
obtaining the binary image of each character of the at least one financial instrument number based on the detected increase in the count of white color pixels in a first location in the binary image and the corresponding decrease in the count of white color pixels in a second location of the binary image.

14. The device as set forth in claim 10, wherein determining the curvature information of each segment further comprises:
expanding at least one of curves or lines and nullifying a gap in the one or more segments, wherein the curvature information is indicative of a presence of the at least one of the curves and lines in each segment;
determining the length of one of the expanded curves or lines;
determining whether the length of the one of the expanded curves or lines exceeds a predetermined threshold; and
detecting the presence of the one of the expanded curves or lines based on the determination.

15. The device as set forth in claim 10, wherein recognizing each character of the at least one financial instrument number further comprises:
comparing the binary image of each character in the at least one financial instrument number with one or more predefined images; and
determining a matching predefined image of each character having an associated accuracy level;
selecting each character having a maximum of the associated accuracy level;
determining whether the associated accuracy level of each selected character exceeds a predetermined threshold; and
displaying the characters of the at least one financial instrument number to a user for confirmation.

16. A non-transitory computer readable medium having stored thereon instructions for enabling a financial transaction comprising machine executable code which when executed by a processor, causes the processor to perform steps comprising:
receiving at least one image of a financial instrument from a sensor;
detecting the presence of the financial instrument in the at least one image;
identifying a location of at least one financial instrument number in the financial instrument;
obtaining a binary image of each character of the at least one financial instrument number from the identified location;
segmenting the binary image of each character into one or more segments; and
recognizing each character of the at least one financial instrument number by determining curvature information of the one or more segments for each character based on one or more attributes.

17. The medium as set forth in claim 16, wherein identifying the location of the at least one financial instrument number further comprises:
converting the at least one image into a corresponding binary image;
identifying at least one group of characters associated with the at least one financial instrument number from the binary image;
determining the location of the at least one group of characters; and
identifying the location of the at least one financial instrument number based the location of the at least one group of characters.

18. The medium as set forth in claim 16, wherein obtaining the binary image of each character in the at least one financial instrument number further comprises:
cropping the at least one image of the at least one financial instrument number from the identified location for each of the at least one images;
converting the cropped image into a corresponding binary image; and
detecting an increase in a count of white color pixels in a first location in the binary image;
detecting a corresponding decrease in a count of white color pixels in a second location in the binary image; and
obtaining the binary image of each character of the at least one financial instrument number based on the detected increase in the count of white color pixels in a first location in the binary image and the corresponding decrease in the count of white color pixels in a second location of the binary image.

19. The medium as set forth in claim 16, wherein determining the curvature information of each segment further comprises:
expanding at least one of curves or lines and nullifying a gap in the one or more segments, wherein the curvature information is indicative of a presence of the at least one of the curves and lines in each segment;
determining the length of one of the expanded curves or lines;
determining whether the length of the one of the expanded curves or lines exceeds a predetermined threshold; and
detecting the presence of the one of the expanded curves or lines based on the determination.

20. The medium as set forth in claim 16, wherein recognizing each character of the at least one financial instrument number further comprises:
comparing the binary image of each character in the at least one financial instrument number with one or more predefined images; and
determining a matching predefined image of each character having an associated accuracy level;
selecting each character having a maximum of the associated accuracy level;
determining whether the associated accuracy level of each selected character exceeds a predetermined threshold; and
displaying the characters of the at least one financial instrument number to a user for confirmation.
